(19) United States
(12) Patent Application Publication
(10) Pub. No.: US 2007/0038593 A1
(43) Pub. Date: Feb. 15, 2007

(54) Data Storage Control Apparatus And Method

(76) Inventors: Daniel S. Critchley, Winchester (GB); Richard H. Hopkins, Southampton (GB); Jonathan I. Settle, Winchester (GB)

Correspondence Address: HARRINGTON & SMITH, L.L.P., 4 RESEARCH DRIVE, SHELTON, CT, 06484-6212, US

(21) Appl. No.: 11/462,199

(22) Filed: Aug. 3, 2006

(30) Foreign Application Priority Data
Aug. 10, 2005 (GB) 0516395.1

(51) Int. Cl. G06F 17/30

(52) U.S. Cl. 707/1

(57) ABSTRACT

An apparatus is operable for writing data to a mirrored storage component, the mirrored storage component being configured to position a data item in a minimum seek time region of a first medium and to position a mirror copy of said data item in a non-minimum seek time region of a second medium. The apparatus includes a data receiving component to receive the data item to be written; a data storing component to store the data item; a first write component to cause writing of the data item to the minimum seek time region of the first medium; and a second write component to cause deferred reading of the data item from the data storing component and deferred writing of the mirror copy to the non-minimum seek time region of the second medium.

### FIELD OF THE INVENTION

The present invention relates to controlling data in redundant data storage, and more particularly to controlling writing of data to storage devices.

### BACKGROUND OF THE INVENTION

Currently data is written to RAID-10 arrays with data spread evenly across the drives. A further refinement, as described in U.S. Pat. No. 6,484,235 allows the drives to return data at their optimal performance by positioning LBAs to use the fastest part of the disk for reads. With the present trend in moving towards the use of slower SATA drives in enterprise level storage, the optimization of drive read I/O becomes ever more important, especially as SATA drives have a longer seek time than existing SCSI drives.

U.S. Pat. No. 6,484,235 discloses reading 50% of the LBAs from one drive, and the other 50% of LBAs from the other, to reduce head movement and therefore also reduce seek times as much as possible. This is achieved by splitting each drive logically into two concentrically arranged parts, such that any given LBA to be read from one drive is nearer the outside, and its corresponding mirror data LBA is nearer the inside of the other drive.

This technique takes advantage of the fact that drives have optimal areas of the platter for performance. This is usually the outside edge, as its rotational speed is identical to that of the inside edge, and the data density remains the same while the area increases. This gives a higher I/O rate.

Currently data is mirrored across drives so that both drives are exact copies of each other. By contrast, according to U.S. Pat. No. 6,484,235, the primary drive contains data as before, but the secondary drive has its logical LBAs reversed. This means that each drive is able to read its part of the data at its optimal rate. The head should only have to leave the optimal area for writes, which usually represent only about 30% of data transfers. Statistically, half of these writes should fall within the optimal area, so only about 15% of transfers will be for data outside the optimal area.

In a further refinement, the LBA boundary can be dynamically moved in order to load balance. All LBAs before the boundary are read from the primary disk, while LBAs after the boundary will be read from the secondary disk. If the primary disk has more load than the secondary, the boundary could be lowered. This means that reads from the primary disk would be fewer, from a smaller area (shorter seeks) and still from the optimal part of the disk, while reads from the secondary drive will still be from its optimal (albeit larger) area.

There remains a problem with the above-described process caused by those writes that force the heads out of the optimal area. It would thus be desirable to have an apparatus and logic method that would combine the advantages of the improved read I/O technique with a more efficient write I/O technique.

### SUMMARY OF THE INVENTION

In accordance with exemplary embodiments of this invention there is provided a computer program comprising computer program code embodied in a computer readable storage medium, execution of the computer program code causing a computer to perform operations that comprise: receiving a data item to be written; storing said data item in a data storing component; causing writing of said data item to a minimum seek time region of a first medium; and causing deferred reading of said data item from said data storing component and deferred writing of a mirror copy of said data item to a non-minimum seek time region of a second medium.

Further in accordance with exemplary embodiments of this invention there is provided an apparatus for writing data to a mirrored storage component, comprising: a data receiving component to receive a data item to be written; a data storing component to store said data item; a first write component to cause writing of said data item to a minimum seek time region of a first medium; and a second write component to cause deferred reading of said data item from said data storing component and deferred writing of a mirror copy of said data item to a non-minimum seek time region of a second medium.

In accordance with further exemplary embodiments of this invention there is provided a method to write data to a mirrored storage component, comprising: receiving a data item to be written; storing said data item in a non-volatile storage; causing writing of said data item to a minimum seek time region of a first data storage medium; and causing deferred reading of said data item from said non-volatile storage and deferred writing of a mirror copy of said data item to a non-minimum seek time region of a second medium.

### BRIEF DESCRIPTION OF THE DRAWINGS

Embodiments of the present invention will now be described, by way of example only, with reference to the accompanying drawing figures, in which:

FIG. 1 shows in schematic form an apparatus in accordance with a preferred embodiment of the present invention.

FIG. 2 shows in flowchart form one logic arrangement or method in which a method of operation according to a preferred embodiment of the present invention may be implemented.

### DETAILED DESCRIPTION OF THE PREFERRED EMBODIMENTS

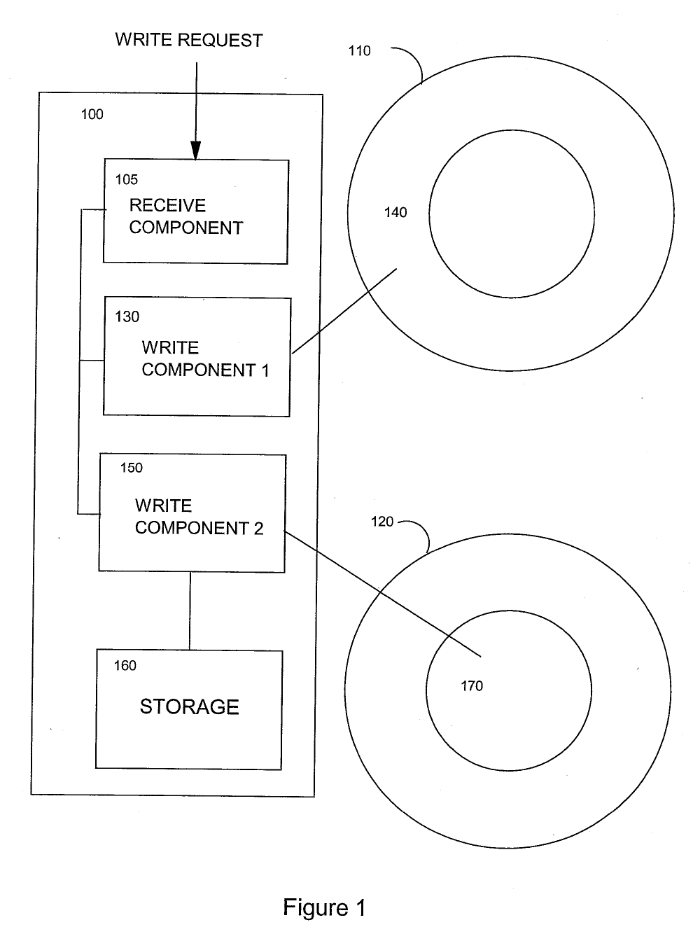

Turning to FIG. 1, there is shown an arrangement of apparatus according to a preferred embodiment of the present invention.

Apparatus 100 is arranged for writing data to mirrored storage, shown as disks 110, 120. The mirrored storage represented by disks 110, 120 is configured to position data items in a minimum seek time region 140 of the first medium—disk 110—and to position a mirror copy of the same data item in a non-minimum seek time region 170 of the second medium—disk 120. Apparatus 100 comprises data receiving component 105 to receive the data item that is to be written. Non-volatile data storing component 160, which may be non-volatile random access memory (NVRAM), is used to store the data item. First write component 130 causes writing, preferably immediate writing, of the data item to the minimum seek time region 140 of disk 110. Second write component 150 causes deferred reading of the data item from the non-volatile storing component 160 and deferred writing of the mirror copy of the data to the non-minimum seek time region 170 of disk 120. Advantageously, the deferred reading and writing of the data item mirror copy may be performed during a period of low activity, and may be performed as a background task that may be pre-empted by other tasks having higher priority, resuming again when peak activity has ended. Although the preferred embodiment of the invention has been shown here implemented with disks 110, 120, any equivalent data storage medium having like arrangements for data storage and retrieval may be contemplated as a suitable environment for further implementations of the present invention. Advantageously, the non-volatile storing component 160 may be disposed to retain more than one data item, such that data items may be batched for more efficient writing, yet further reducing the need for drive head repositioning. This batching of writes limits the excursions from the optimal area to batches, thus reducing the amount of seeking the drive will have to do outside the optimal area when writing data to disk. Such techniques are known in the art, and conventionally involve marking data or parity “in doubt” until the batch write is completed. The risk to data is higher than would otherwise be the case, but this is traded-off against increased performance, and the risk may be reduced by means of known data integrity techniques. By using atomic parity in NVRAM, for example, both an adapter failure and data corruption from an outstanding write would have to occur in order to cause data loss.

A possible modification would be, in effect, to maintain the non-volatile storage component 160 of the preferred embodiment in the drives themselves, and to modify the disk firmware accordingly in such a way that the I/O could be sent to both drives 110 and 120 simultaneously as with normal RAID. The drive's ageing algorithm would then be modified to age writes to the non-minimum seek areas of the disks more slowly. The drive in control of the non-minimum seek area would thus form larger buffers of write data and thereby automatically batch writes outside the optimal area more efficiently.

In any case, data items in the non-volatile storage component are maintained for as long as is necessary to ensure that the writes to both the minimum seek area 140 of the first disk 110 and to non-minimum seek area 170 of the second disk 120 have reached successful completion. The non-volatile storage component 160 may then be cleared ready for the data item or items associated with the next write request.

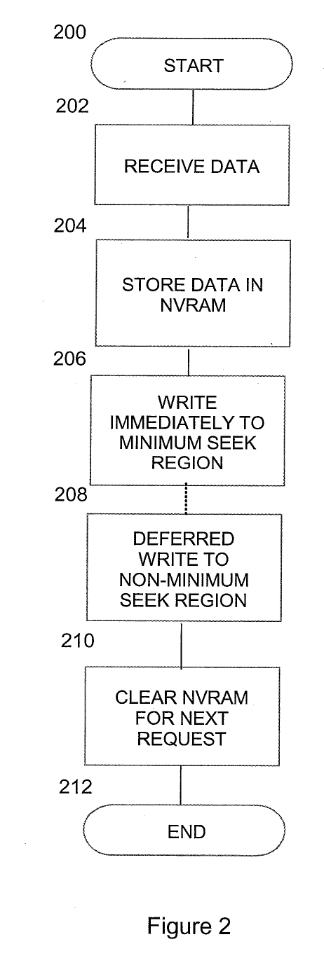

Turning now to FIG. 2, there are shown in flowchart form the steps of a method or logic arrangement according to a preferred embodiment of the present invention.

In the method for operating an apparatus for writing data to mirrored storage shown in FIG. 2, the mirrored storage is configured to position a data item in a minimum seek time region of a first medium and positioning a mirror copy of the data item in a non-minimum seek time region of a second medium. The method begins at START step 200, and at step 202, a data receiving component receives the data item to be written. Typically, the data item is received as a result of a host write I/O, but alternatives are contemplated, such as non-host copy service requests from peer controllers, adapters or storage virtualization engines in a data storage network, such as a storage area network (SAN). At step 204, a non-volatile data storing component stores the data item. The non-volatile storage component may make use of, for example, NVRAM to store the data, in order to improve data integrity and recoverability. At step 206, a first write component causes writing, preferably immediate writing of the data item to the minimum seek time region of the first medium. This write may use the data from the non-volatile data storing component. In an alternative, the data item may be written directly, without being written to and subsequently read from the non-volatile data storing component.

The dotted line in the flow chart here indicates that there may be a delay of indeterminate length between immediate write step 206 and the succeeding step, step 208, in which a second write component causes the deferred reading of the data item from non-volatile storage and deferred writing of a mirror copy of the data item to the non-minimum seek region of the second medium. The contents of the non-volatile storage are no longer required after step 208, and thus, at step 210, the non-volatile storage may be cleared ready to receive one or more data items for any further write requests. At END step 212, the method steps end.

It will be clear to one skilled in the art that the method of the present invention may suitably be embodied in a logic apparatus comprising logic means to perform the steps of the method, and that such logic means may comprise hardware components or firmware components.

It will be equally clear to one skilled in the art that the logic arrangement of the present invention may suitably be embodied in a logic apparatus comprising logic means to perform the steps of the method, and that such logic means may comprise components such as logic gates in, for example, a programmable logic array. Such a logic arrangement may further be embodied in enabling means for temporarily or permanently establishing logical structures in such an array using, for example, a virtual hardware descriptor language, which may be stored using fixed or transmittable carrier media.

It will be appreciated that the method described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

The present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

It will be further appreciated that embodiments of the present invention may be provided in the form of a service deployed on behalf of a customer to offer service on demand.

Based on the foregoing it can be appreciated that the exemplary embodiments of this invention provide, in a first aspect, an apparatus for writing data to a mirrored storage component, said mirrored storage component being configured to position a data item in a minimum seek time region of a first medium and to position a mirror copy of said data item in a non-minimum seek time region of a second medium; said apparatus comprising: a data receiving component to receive said data item to be written; a data storing component to store said data item; a first write component to cause immediate writing of said data item to said minimum seek time region of said first medium; and a second write component to cause deferred reading of said data item from said data storing component and deferred writing of said mirror copy to said non-minimum seek time region of said second medium.

Based on the foregoing it can be appreciated that the exemplary embodiments of this invention provide, in a second aspect, a method for operating an apparatus for writing data to a mirrored storage component, where said mirrored storage component being configured to position a data item in a minimum seek time region of a first medium and to position a mirror copy of said data item in a non-minimum seek time region of a second medium. The method comprises steps of: receiving, by a data receiving component, said data item to be written; storing, by a data storing component, said data item; causing, by a first write component, immediate writing of said data item to said minimum seek time region of said first medium; and causing, by a second write component, deferred reading of said data item from said data storing component and deferred writing of said mirror copy to said non-minimum seek time region of said second medium.

Based on the foregoing it can be appreciated that the exemplary embodiments of this invention provide, in a further aspect, a computer program comprising computer program code to, when loaded into a computer system and executed thereon, cause said computer system to perform all the steps of a method according to the second aspect. Preferred method step features of the second aspect are reflected in preferred computer program features of the third aspect.

In the foregoing aspects at least one of said first medium and said second medium may comprise disk storage, the minimum seek time region comprises an outer region of a disk platter, the non-minimum seek time region comprises an inner region of a disk platter, and the data storing component comprises non-volatile storage. The non-volatile storage may comprise NVRAM. The data storing component may cleared after said deferred writing has completed. The data storing component may be operable to batch a plurality of data items. The deferred writing of the mirror copy may be operable during times of reduced activity, and may be interruptible by higher-priority work.

The preferred embodiment of the present invention thus preferably only writes data instantly to the drive that has the relevant LBA in its optimal area, which is fast, and buffers and preferably batches up writes for the other drive so that its head only makes infrequent excursions outside its optimal area.

It will also be appreciated that various further modifications to the preferred embodiment described above will be apparent to a person of ordinary skill in the art.

What is claimed is:

1. A computer program comprising computer program code embodied in a computer readable storage medium, execution of the computer program code causing a computer to perform operations that comprise:
receiving a data item to be written;
storing said data item in a data storing component;
causing writing of said data item to a minimum seek time region of a first medium; and
causing deferred reading of said data item from said data storing component and deferred writing of a mirror copy of said data item to a non-minimum seek time region of a second medium.

2. The computer program of claim 1, wherein at least one of said first medium and said second medium comprises disk storage.

3. The computer program of claim 1, wherein said minimum seek time region comprises an outer region of a disk platter.

4. The computer program of claim 1, wherein said non-minimum seek time region comprises an inner region of a disk platter.

5. The computer program of claim 1, wherein said data storing component comprises non-volatile storage.

6. The computer program of claim 5, wherein said non-volatile storage comprises NVRAM.

7. The computer program of claim 1, further comprising clearing said data storing component after said deferred writing has completed.

8. The computer program of claim 1, wherein said data storing component is operable to batch a plurality of data items.

9. The computer program of claim 1, wherein said deferred writing of said mirror copy is operable during times of reduced activity.

10. The computer program of claim 1, wherein said deferred writing of said mirror copy is interruptible by higher-priority work.

11. An apparatus for writing data to a mirrored storage component, comprising:
a data receiving component to receive a data item to be written;
a data storing component to store said data item;
a first write component to cause writing of said data item to a minimum seek time region of a first medium; and
a second write component to cause deferred reading of said data item from said data storing component and deferred writing of a mirror copy of said data item to a non-minimum seek time region of a second medium.

12. An apparatus as claimed in claim 11, wherein at least one of said first medium and said second medium comprises disk storage.

13. An apparatus as claimed in claim 11, wherein said minimum seek time region comprises an outer region of a disk platter, and wherein said non-minimum seek time region comprises an inner region of a disk platter.

14. An apparatus as claimed in claim 11, wherein said data storing component comprises non-volatile storage.

15. An apparatus as claimed in claim 14, wherein said non-volatile storage comprises NVRAM.

16. An apparatus as claimed in claim 11, wherein said data storing component is cleared after said deferred writing has completed.

17. An apparatus as claimed in claim 11, wherein said data storing component is operable to batch a plurality of data items.

18. An apparatus as claimed in claim 11, wherein said deferred writing of said mirror copy is operable during times of reduced activity, and is interruptible by higher-priority work.

19. A method to write data to a mirrored storage component, comprising:
receiving a data item to be written;
storing said data item in a non-volatile storage;
causing writing of said data item to a minimum seek time region of a first data storage medium; and
causing deferred reading of said data item from said non-volatile storage and deferred writing of a mirror copy of said data item to a non-minimum seek time region of a second medium.

20. A method as claimed in claim 19, wherein said minimum seek time region comprises an outer region of a disk platter, wherein said non-minimum seek time region comprises an inner region of a disk platter.
